(19) United States
(12) Patent Application Publication
(10) Pub. No.: US 2005/0278992 A1
(43) Pub. Date: Dec. 22, 2005

(54) Calendar holder

(76) Inventor: Kikuko Takeda, Shizuoka-ken (JP)

Correspondence Address: FLYNN THIEL BOUTELL & TANIS, P.C., 2026 RAMBLING ROAD, KALAMAZOO, MI, 49008-1631, US

(21) Appl. No.: 11/153,162

(22) Filed: Jun. 15, 2005

(30) Foreign Application Priority Data
Jun. 16, 2004 (JP) 2004-177789

(51) Int. Cl. G09D 3/04

(52) U.S. Cl. 40/120

(57) ABSTRACT

A calendar holder, wherein a calendar can be held by a retainer, which eliminates insertion of a fixing member into a structure again and again when the calendar includes many pages, e.g. for each month. This avoids damage to the structure and enhances the appearance of the structure. The calendar holder for placing on a structure includes a holder body that is hung from the structure. The holder body includes at least a retainer that holds the calendar.

### FIELD OF THE INVENTION

This invention relates to calendar holders, and more particularly to a calendar holder that permits easier placement on structures such as walls or columns without damage to the structure.

### BACKGROUND OF THE INVENTION

Generally, when placing a calendar on structures such as walls and columns, the calendar is secured to the structure by inserting a fixing member, such as thumbtack or nail, into a through-hole provided in an upward center region of the calendar, and inserting the fixing member into the structure.

In JP Laid-Open No. H10-16439, there is disclosed a suspender for the calendar in which a body thereof includes a receiving section adjacent the upper center of the body, a tongue-shaped section at one end of the body, a cut between the receiving and tongue-shaped sections, a suspending section at the other end of the body, and a hole for a string in a head of the suspending section.

However, since the fixing member is inserted into the structure when placing the calendar on structures such as walls and columns, the fixing member is removed from the structure and is again inserted into the structure at the beginning of every month when the calendar includes more than one page, e.g. for every month. Insertion of the fixing member into the structure again and again damages the structure and appearance.

In order to obviate the above inconveniences, the present invention provides a calendar holder for placing on a structure which includes a holder body that is hung from the structure. The holder body includes at least a retainer that holds the calendar.

According to the present invention, the calendar is held by the retainer of the holder body that is hung from the structure. This eliminates the need for insertion of a fixing member into the structure again and again at the beginning of every month when the calendar includes many pages, e.g. for each month. Accordingly, damage to the structure is avoided and the appearance of the structure is maintained.

By the calendar being held by the retainer of the holder body, the present invention achieves the object of avoiding damage to the structures such as walls and columns due to the placing of the calendar thereon.

### BRIEF DESCRIPTION OF THE DRAWINGS

Embodiments of the present invention will now be described with reference to the drawings, in which:

FIG. 1 is a front view of the calendar holder according to the first embodiment, showing the situation wherein the calendar is held by the retainer of the holder body.

FIG. 2 is a front view of the calendar holder according to the first embodiment, with the ornaments removed for illustrative purposes.

FIG. 3(A) is a front view of the retainer.

FIG. 3(B) is a side view of the retainer.

FIG. 4 is a partial side view showing the hook member locked to the bar, according to the first embodiment.

FIG. 5 is a front view of the calendar holder according to the second embodiment.

FIG. 6 is a partial side view showing the L-shaped seizing member locked to the bar, according to the third embodiment.

### DETAILED DESCRIPTION

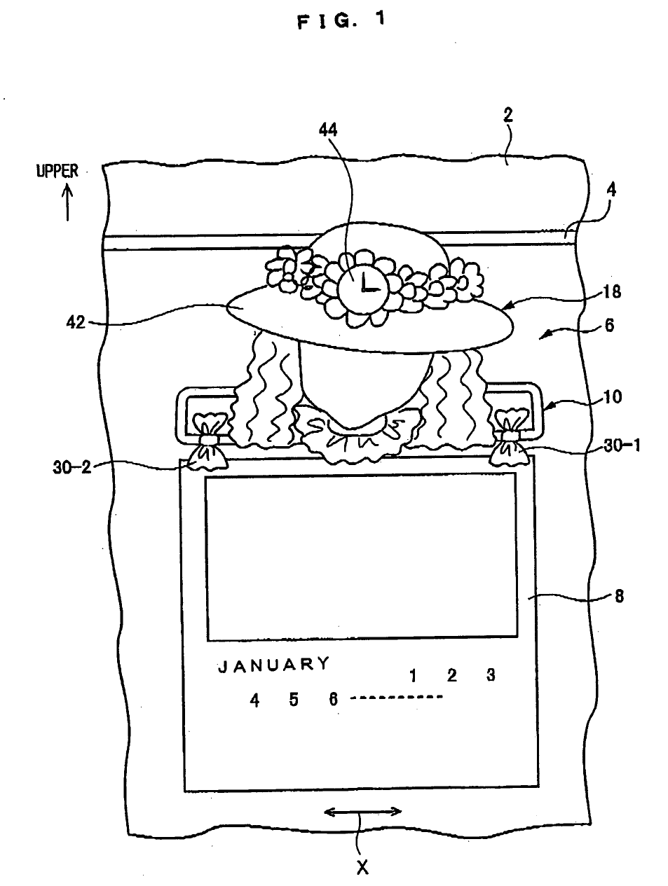

FIGS. 1-4 illustrate a first embodiment of the present invention. In FIGS. 1 and 4, the reference numeral 2 designates a structure of the building or room such as a wall or column, and numeral 4 designates a bar fixed to the structure 2. A calendar 8 is attached to the bar 4 through a calendar holder 6.

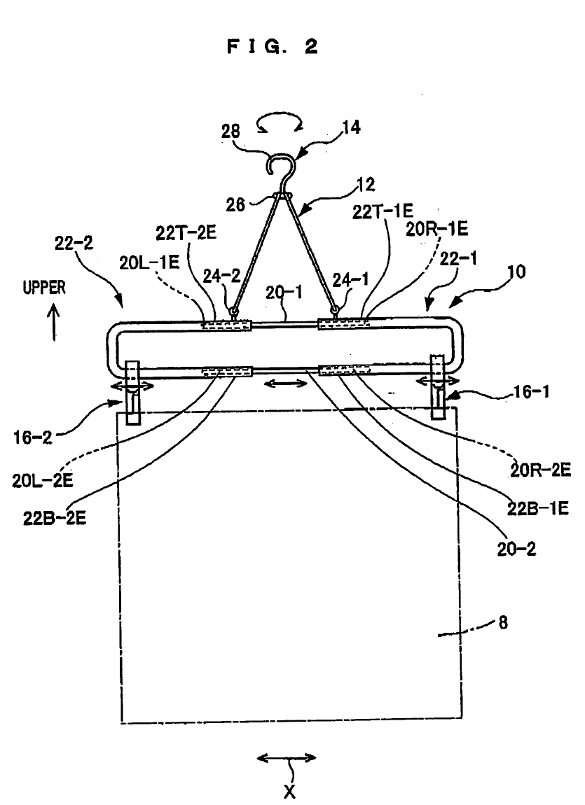

As shown in FIGS. 1 and 2, the calendar holder 6 includes a holder body 10, a string member 12 to hold the holder body 10 to the bar 4, a hook member 14, a pair of right and left retainers 16-1, 16-2 in the holder body 10, and an ornament 18.

As shown in FIG. 2, the holder body 10 is formed by a rectangular pipe material made of e.g. aluminum or plastic. The holder body 10 includes, at the center, straight and parallel upper and lower first pipe materials 20-1, 20-2. The holder body 10 also includes U-shaped right and left second pipe materials 22-1, 22-2 that are disposed to the right and left of the upper and lower first pipe materials 20-1, 20-2, respectively.

In the holder body 10, the U-shaped lateral right and left second pipe materials 22-1, 22-2 and the straight upper and lower first pipe materials 20-1, 20-2 are joined together, while permitting insertion and removal, to allow expansion and contraction in a sideward direction X of the calendar 8 to adapt to the width of the calendar 8.

More particularly, a right end 20R-1E of the first upper pipe material 20-1 and a right end 20R-2E of the first lower pipe material 20-2 are inserted and joined into an upper end 22T-1E and a lower end 22B-1E of the second right pipe material 22-1, respectively. Also, a left end 20L-1E of the first upper pipe material 20-1 and a left end 20L-2E of the first lower pipe material 20-2 are inserted and joined into an upper end 22T-2E and a lower end 22B-2E of the second left pipe material 22-2, respectively.

Right and left string receivers 24-1, 24-2 are fixed to the upper end 22T-1E of the second right pipe material 22-1 and the upper end 22T-2E of the second left pipe material 22-2, respectively. Both ends of the string member 12 are attached to the right and left string receivers 24-1, 24-2.

The hook member 14 is attached to the center region of the string member 12. The hook member 14 includes a string attaching section 26 to hold the string member 12, and a hook section 28 that rotates with respect to the string attaching section 26.

Right and left retainers 16-1, 16-2 are mounted to the lower end 22B-1E of the second right pipe material 22-1 and the lower end 22B-2E of the second left pipe material 22-2 of the holder body 10. As shown in FIG. 1, the right and left retainers 16-1, 16-2 are provided with designed ornaments 30-1, 30-2.

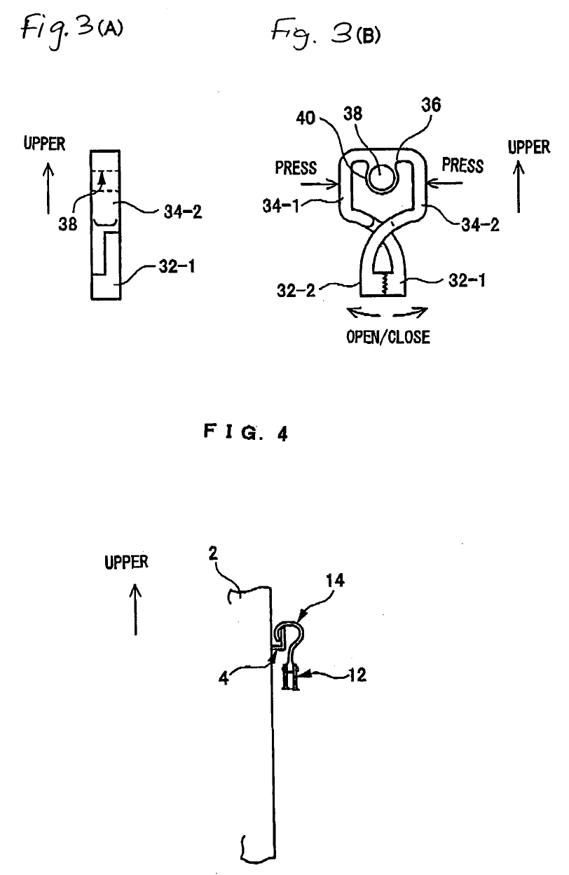

Referring to FIGS. 3(A) and 3(B), the retainers 16-1, 16-2 each include first and second pinching sections 32-1, 32-2, first and second press sections 34-1, 34-2, an upper spring section 36, and an annular fixing section 40. More particularly, the first and second pinching sections 32-1, 32-2 grasp and hold the respective ends of the upper part of the calendar 8. The first and second press sections 34-1, 34-2 cross one another and are connected with the respective first and second pinch sections 32-1, 32-2. The upper spring section 36 is connected with the first and second press sections 34-1, 34-2. The annular fixing section 40 includes a hole section 38 that is secured inwardly of the spring section 36 to allow insertion of the lower ends 22B-1E, 22B-2E therethrough. The force of the spring section 36 usually urges the first and second pinching sections 32-1, 32-2 into contact each other. When the first and second press sections 34-1, 34-2 are pressed in a direction towards one another, the pinch sections 32-1, 32-2 are moved away from one another in opposition to the force of the spring section 36. The retainers 16-1, 16-2 are axially movable along the lower ends 22B-1E, 22B-2E as these lower ends 22B-1E, 22B-2E are inserted into the hole section 38.

The holder body 10 and the string member 12 are provided with the ornament 18 by any suitable means (not shown), such as a hanger, clip, etc. As shown in FIG. 1, the ornament 18 includes, e.g., a hat 42 and a clock 44, which can be variably replaced.

Operation of the first embodiment is explained as follows.

For attaching the calendar 8 to the structure 2, the hook member 14 is locked to the bar 4 as shown in FIG. 4. The ornament 18 is positioned over the string member 12 and hook 14 as shown in FIG. 1. By adjusting the retainers 16-1, 16-2, the upper part of the calendar 8 is held.

At the beginning of the next month, the calendar is detached by operation of the retainers 16-1, 16-2, the page of the last month is removed, and the upper part of the calendar 8 is again held by the retainers 16-1, 16-2.

This eliminates the insertion of the conventional fixing member into the structure 2 every month when the calendar 8 includes many pages, e.g. for each month, which avoids damage to the structure 2. The calendar is decorated with the ornament 18 that covers the string member 12 and the hook member 14 to enhance the appearance of the overall arrangement.

The holder body 10 is formed by the pipe material made of e.g. aluminum and plastic, which provides a lightweight structure, easier handling, and cost savings.

FIG. 5 illustrates a second embodiment of the present invention.

The same reference numerals are hereinafter utilized for features identical or similar in function to those described in the first embodiment.

The second embodiment is characterized as follows. Between the right and left second pipe materials 22-1 and 22-2, the holder body 10 includes a spring 52 that has both ends attached to the right and left second pipe materials 22-1, 22-2 to urge these pipes 22-1, 22-2 in a contracting direction. Between the upper end 22T-1E of the second right pipe material 22-1 and the upper end 22T-2E of the second left pipe material 22-2, a certain space S is formed that is wider than the structure 2, e.g. a wall, that is vertically positioned. The upper end 22T-1E of the second right pipe material 22-1 and the upper end 22T-2E of the second left pipe material 22-2 are provided with right and left contact sections 54-1, 54-2 of a wide area, which contact sections 54-1, 54-2 are in contact with the sides of the structure 2.

According to the second embodiment, the right contact section 54-1 makes contact with a first side 2F-1 of the structure 2, e.g. a wall, and the left contact section 54-2 contacts with a second side 2F-2 of the structure 2. Thereby, the holder body 10 can be attached to the structure 2 without the string material or the hook material. The holder body 10 can also be attached to the structure 2 without the bar. This reduces the number of components, simplifies the structure and reduces costs.

Incidentally, with the second embodiment, the holder body 10 can be hanged from the bar laterally (vertically) positioned.

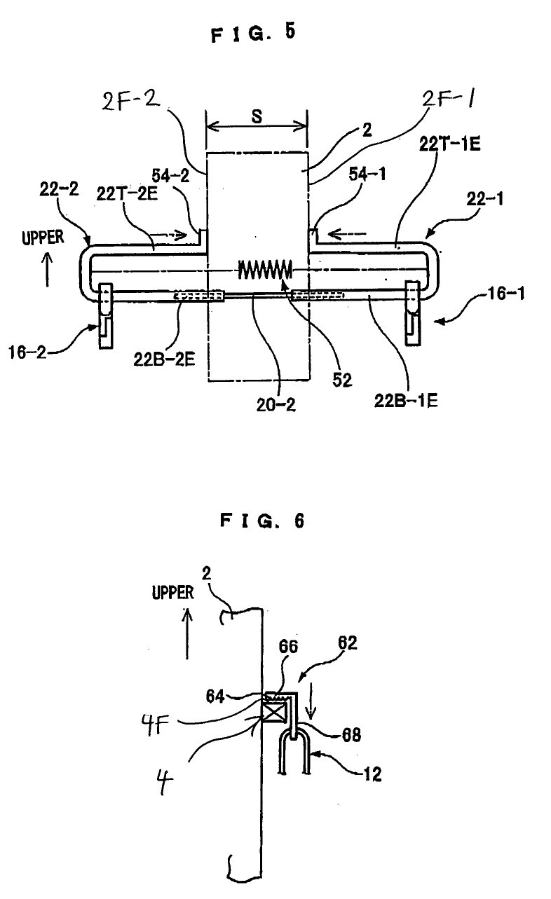

FIG. 6 illustrates a third embodiment of the present invention.

The third embodiment is characterized by an L-shaped seizing member 62 which defines a hook member. The seizing member 62 includes a first member 66 provided with a slip-preventing surface or section 64 in contact with a top surface 4F of the bar 4, and a second member 68 which projects downwardly from section 64 and holds the string member 12.

According to the third embodiment, by only positioning the slip-preventing section 64 of the first member 66 of the seizing member 62 onto the top surface 4F of the bar 4, the holder body 10 is hanged from the bar 4, which is convenient. The slip-preventing section 64 prevents the detachment of the holder body 10 from the bar 4, so that the holder body 10 is securely suspended.

The calendar holder, in which the retainer of the calendar holder holds the calendar, can be applied to hold other objects such as memos, letter files, and pictures.

Although a particular preferred embodiment of the invention has been disclosed in detail for illustrative purposes, it will be recognized that variations or modifications of the disclosed apparatus, including the rearrangement of parts, lie within the scope of the present invention.

1. A calendar holder for placing on a structure, comprising a holder body that is hung from the structure, the holder body being provided with at least a retainer that holds the calendar.

2. The calendar holder according to claim 1, wherein in the holder body, an end of a first pipe material and an end of a second pipe material are joined together, while permitting insertion and removal, to allow expansion and contraction in a sideward direction of the calendar.

3. The calendar holder according to claim 1, wherein the holder body includes an ornament.

4. A holder arrangement for positioning a calendar on a structure of a building, said arrangement comprising a holder body including a fastening element configured for removable attachment to a static mounting structure provided on the building structure so as to suspend the calendar therefrom, said holder body further including a retainer element which removably attaches to a portion of the calendar.

5. The holder arrangement according to claim 4, wherein said holder body includes a pair of said retainer elements which removably attach to laterally-spaced portions of the calendar.

6. The holder arrangement according to claim 5, wherein said retainer elements each comprise a spring-clip which grips an upper edge of the calendar.

7. The holder arrangement according to claim 4, wherein said fastening element comprises a hook which engages over the static mounting structure.

8. The holder arrangement according to claim 7, wherein said fastening element defines thereon a slip-resistant surface which contactingly engages an upper surface of the static mounting structure.

9. The holder arrangement according to claim 4, wherein said holder body is defined by a pair of opposed and generally U-shaped elements which are adjustably fastened to one another to accommodate calendars of variable widths.

10. The holder arrangement according to claim 9, wherein said U-shaped elements are generally pipe-shaped, and said holder body includes upper and lower linear elements which are generally parallel to one another, a pair of free outer ends of said upper element being telescopingly disposed within respective inner free ends of upper legs of the respective U-shaped elements, and a pair of free outer ends of said lower element being telescopingly disposed within respective free inner ends of lower legs of the respective U-shaped elements.
